(19) United States
(12) Patent Application Publication
(10) Pub. No.: US 2009/0053941 A1
(43) Pub. Date: Feb. 26, 2009

(54) Spring contact for an electrical plug connection and plug connection

(76) Inventor: Franc Stuklek, Celje (SI)

Correspondence Address: Pauley Petersen & Erickson, Suite 365, 2800 W. Higgins Road, Hoffman Estates, IL, 60169, US

(21) Appl. No.: 12/218,618

(22) Filed: Jul. 16, 2008

(30) Foreign Application Priority Data
Jul. 16, 2007 (DE) 10 2007 032 992.1

(51) Int. Cl. H01R 13/05

(52) U.S. Cl. 439/825

(57) ABSTRACT

A spring contact for an electrical plug connection, which at one end has at least two opposing spring-elastic contact legs for receiving a counterpart contact that can be inserted between the two contact legs in an insertion direction along a central longitudinal axis of the spring contact. The outsides of the contact legs oriented away from the central longitudinal axis are each engaged by respective spring legs which press the respective opposing contact legs toward each other perpendicular to the central longitudinal axis and, when a counterpart contact is inserted, exert a respective contact pressure on the latter. A plug connection can be equipped with at least one spring contact of this invention. A plug connection of this invention can be used between a power tool and a rechargeable battery.

### BACKGROUND OF THE INVENTION

1. Field of the Invention This invention relates to a spring contact for an electrical plug connection, which has at least two spring-elastic contact legs situated opposite each other at one end for receiving a counterpart contact that can be inserted between the two contact legs in an insertion direction along a central longitudinal axis of the spring contact. This invention also relates to a plug connection with at least one spring contact of this kind.

2. Discussion of Related Art

Spring contacts for receiving knife blade contacts are known from the prior art. Particularly in battery-operated power tools such as rotary hammers, the batteries or rechargeable batteries are electrically contacted to the power tool via rigid knife blade contact strips and spring contact strips. Ever more powerful battery-operated power tools have been developed in which sometimes, high peak currents of up to 150 amperes flow. These high currents place particularly powerful stresses on the plug connection between the rechargeable battery and the power tool. The rigid knife blade contact strips and spring contact strips used previously have the disadvantage that the two contact strips must be exactly flush with each other to produce a sufficient electrical contact. But if the contact strips or individual contacts are not flush with one another, then vibrations of the kind that occur, for example in rotary hammers, can result in contact erosion due to insufficiently large contact areas and contacting forces.

### SUMMARY OF THE INVENTION

One object of this invention is to provide a spring contact and a plug connection with a spring contact, which can offer an improved contacting between the spring contact and a counterpart contact.

This object of this invention is attained by a spring contact and by a plug connection having characteristics described in this specification and in the claims.

In the spring contact according to this invention, a respective spring leg engages each of the outsides of the contact legs oriented away from the central longitudinal axis. The spring legs press the opposing contact legs toward each other, perpendicular to the central longitudinal axis. When a counterpart contact is inserted, the spring legs each exert a respective contact pressure on the counterpart contact.

The contact legs are embodied as spring-elastic and very flexible so that when contacting a counterpart contact, they compensate for tolerances that can arise between the counterpart contact and the spring contact. The spring contacts, which can be embodied as steel springs, assure a uniform contact pressure on both sides of the inserted counterpart contact, even when the counterpart contact is not precisely flush with the spring contact. The contacting force can be simply adapted to a desired application through the selection of suitable steel springs and of the material and geometry of the spring legs.

According to one preferred embodiment, a plurality of spring-elastically suspended contact legs can be arranged in pairs opposite one another at one end of the spring contact according to this invention so that the counterpart contact can be inserted between the opposing pairs of contact legs in the insertion direction along the central longitudinal axis of the spring contact, with a respective spring leg engaging the outside of each contact leg. The contact area between the contact legs and the counterpart contact is enlarged significantly by the parallel arrangement of a plurality of pairs of contact legs that permit the insertion of a counterpart contact embodied, for example, in the form of a knife blade. In this case, the contacting remains even if there is a lateral offset or an angular tilt between the contact legs and the counterpart contact.

A particularly reliable contacting can be achieved if the contact legs situated opposite each other are approximately V-shaped at their free ends. This forms V-shaped contact elements that extend toward each other and contact the counterpart contact when inserted.

In order for the counterpart contact to be easily inserted between the opposing contact legs, the free ends of the latter can be embodied as bent and the free ends oriented away from each other.

According to another embodiment of this invention, the other end of the spring contact can have a soldering lug formed onto it, which permits the spring contact to be soldered directly to a printed circuit board. The ability of the spring contact to be soldered directly to the printed circuit board permits the spring contact according to this invention to be easily connected to an electronic circuit. The spring-elasticity and flexibility of the contact legs assure the mobility required for a tolerance compensation, despite the rigid connection to the printed circuit board.

A particularly stable connection between the spring contact and the printed circuit board can be achieved if a plurality of soldering pins are formed onto the soldering lug. In this case, the soldering pins can extend perpendicular to the central longitudinal axis of the spring contact and can thus be easily inserted into soldering holes in the printed circuit board.

The spring contact according to this invention can be manufactured in a particularly simple fashion, if from a production engineering standpoint, the contact legs and the soldering lug with the soldering pins are integrally formed out of a metal sheet with a high electrical conductivity.

A particularly good transmission of contact pressure can be achieved if the spring legs extend essentially parallel to the associated contact legs. This design is particularly compact.

According to yet another embodiment, the spring legs can be formed onto the parallel extending support walls of an essentially U-shaped spring element. The spring element in this case can embrace the opposing contact legs so that the insides of the support walls come to rest against the outsides of the contact legs. Thus, the spring element is embodied in a form of a separate component produced, for example, of steel and can easily be placed onto the contact leg arrangement during assembly of the spring contact.

In order to prevent the spring element, which is placed onto the contact leg arrangement, from being able to slide out of its functioning position, the outsides of the contact legs can be situated opposite each other to each have at least one respective hollow embodied in them and for the insides of the spring legs oriented toward the contact legs to each have a corresponding respective projection formed onto them, which engages in the respective hollow.

According to another fundamental concept of this invention, a plug connection can have at least one spring contact of this invention. It is possible for a plurality of spring contacts to be soldered parallel to one another on one side of a printed circuit board.

In order to protect the plug connection from external influences and to securely accommodate the individual components, the spring contacts can be supported from underneath by a shared lower housing component and can be covered from above by a shared upper housing component.

It is possible for the printed circuit board to be at least partially supported by the lower housing component and at least partially covered by the upper housing component. Thus, the upper housing component can be of several parts and have at least one region in which a housing cover is embodied.

In order to achieve a stable connection between the lower housing component and the upper housing component, in the region of or near the spring contacts and perpendicular to the central longitudinal axis, the lower housing component can have a plurality of recesses for receiving projections that are formed onto the upper housing component and protrude in a comb-like fashion in the direction of the lower housing component.

The spring contact according to this invention can be securely held in a simple fashion with the contact legs with the spring legs resting against them guided through the vertical slots that are defined between the recesses of the lower housing component and the projections of the upper housing component. In this instance, the slot width is determined by a sheet thicknesses of the contact legs and the spring legs.

When the bottom housing component and the upper housing component are assembled, cavities can be formed in which the spring contacts are situated. The cavities offer the spring contacts the freedom of movement required for a tolerance compensation. In order to insert counterpart contacts into the spring contacts, the cavities are open at least in the insertion direction of the counterpart contacts.

So that knife blade contacts can also be inserted into the plug connection, each of the cavities can contain at least two opposing slots, which are extending perpendicular to the central longitudinal axis and are used for the insertion of a respective knife blade contact. During insertion, a knife blade contact is oriented so that it extends between two contact legs situated opposite each other. The opposing slots are thus situated in a plane defined by the knife blade contact.

### BRIEF DESCRIPTION OF THE DRAWINGS

This invention is explained in greater detail below in view of a preferred embodiment with reference to the accompanying drawing, wherein:

FIG. 1 is a schematic top view of a spring contact;

FIG. 2 is a schematic side view of the spring contact shown in FIG. 1;

FIG. 3 is a schematic, perspective, exploded view of the spring contact shown in FIGS. 1 and 2;

FIG. 4 is a schematic, partially sectional top view of a plug connection in which an upper housing component is of two parts and in which the part of the upper housing component that covers a connected printed circuit board is removed; and

FIG. 5 is a schematic, partially sectional front view of the plug connection shown in FIG. 4.

### DETAILED DESCRIPTION OF THE INVENTION

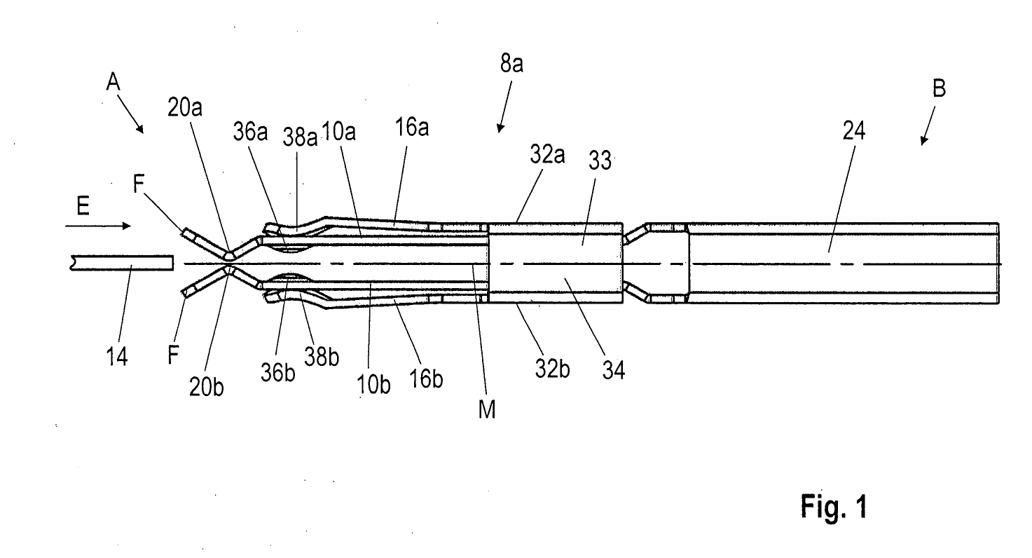

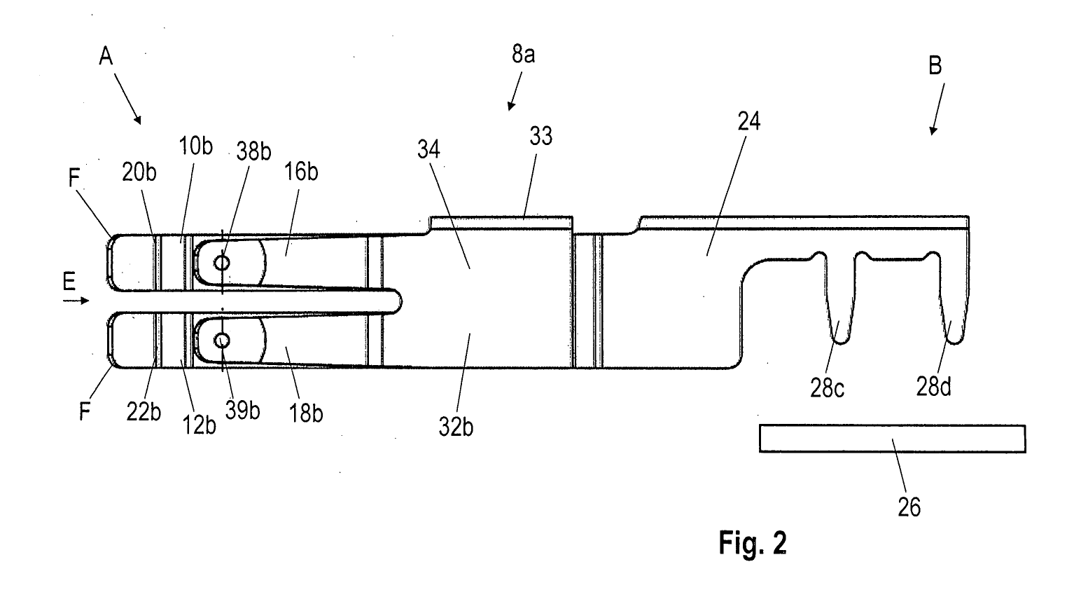

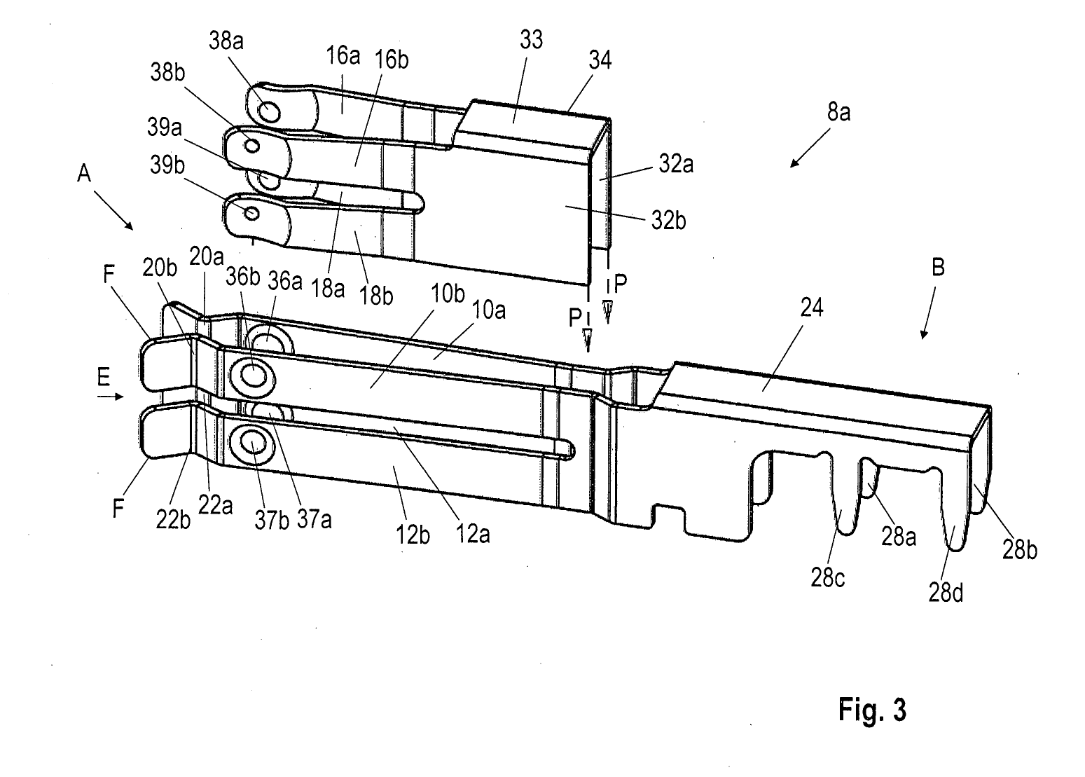

FIGS. 1 through 3 schematically show different views of a spring contact 8a for an electrical plug connection. FIG. 1 is a top view of the spring contact 8a, FIG. 2 is a side view, and FIG. 3 is a perspective, exploded view.

At its end A oriented toward the left in FIGS. 1 through 3, the spring contact 8a has four spring-elastic contact legs 10a, 10b, 12a and 12b arranged opposite each other in pairs. A counterpart contact 14, which is only suggested in the depiction in FIG. 1, can be inserted between the opposing pairs of contact legs 10a and 10b; 12a and 12b in an insertion direction E along the central longitudinal axis M of the spring contact. The counterpart contact 14 is in a form of a knife blade contact.

Spring legs 16a, 16b, 18a, and 18b respectively engage each of the contact legs 10a, 10b, 12a, and 12b on their outsides oriented away from the central longitudinal axis M. The spring legs 16a, 16b, 18a, and 18b extend parallel to the associated contact legs 10a, 10b, 12a, and 12b. The spring legs 16a, 16b, 18a, and 18b each press the respective opposing contact legs 10a, 10b, 12a, and 12b toward each other in the direction perpendicular to the central longitudinal axis M. As a result, a contact pressure is exerted on the counterpart contact 14 when it is inserted between the two opposing contact leg pairs 10a, 10b, and 12a, 12b. In the depiction shown in FIG. 1, the counterpart contact 14 is in the non-inserted state. The inserted state, however, is not shown in the drawings.

The contact legs 10a and 10b, 12a and 12b situated opposite each other are embodied as approximately V-shaped at their free ends F and form V-shaped contact elements 20a and 20b; 22a and 22b extending toward each other. The contact elements 20a and 20b; 22a and 22b contact the counterpart contact 14 when it is in the inserted state, not shown in the drawings.

The contact legs 10a and 10b; 12a and 12b situated opposite each other are embodied as bent at their free ends F and the free ends F are oriented away from each other.

At its right end B in FIGS. 1 through 3, the spring contact 8a has a soldering lug 24 that permits the spring contact 8a to be soldered directly to a printed circuit board, which is shown in only schematic form in FIG. 2 and has the reference numeral 26. As shown in FIG. 3, four soldering pins 28a, 28b, 28c, and 28d, which are situated at the comers of a rectangle, are formed onto the soldering lug 24 and extend perpendicular to the central longitudinal axis M of the spring contact 8a. The soldering pins 28a, 28b, 28c, and 28d can be inserted into soldering holes 30 (not shown) provided on the printed circuit board 26 and soldered in place there.

The contact legs 10a, 10b, 12a, and 12b and the soldering lug 24 with the soldering pins 28a, 28b, 28c, and 28d are integrally formed out of a metal sheet.

As shown in FIG. 3, the spring legs 16a and 18a are formed onto the support wall 32a of an essentially U-shaped spring element 34 and the spring legs 16b and 18b are formed onto its support wall 32b. The two support walls 32a and 32b are positioned parallel to each other and are attached to each other by a bridge piece 33. The two support walls 32a and 32b that are attached to each other by the bridge piece 33, together with the spring legs 16a, 16b, 18a, and 18b form a spring element 34. The spring element 34 is integrally formed out of a steel sheet.

The spring element 34 embraces the opposing contact legs 10a and 10b, 12a and 12b so that the insides of the support walls 32a and 32b come to rest against the outsides of the contact legs 10a and 10b, 12a and 12b. FIG. 3 shows a state in which the spring element 34 is lifted up from the contact legs 10a and 10b, 12a and 12b. The spring element can be placed onto the contact legs 10a and 10b, 12a and 12b in the direction of the arrows P.

The outsides of the opposing contact legs 10a and 10b each have a hollow 36a and 36b in them and the outsides of the opposing contact legs 12a and 12b each have a hollow 37a and 37b in them. The insides of the spring legs 16a and 16b oriented toward the contact legs 10a and 10b each has a corresponding formed on projection 38a and 38b. The insides of the spring legs 18a and 18b oriented toward the contact legs 12a and 12b each has a corresponding projection 39a and 39b formed onto them. The projections 38a and 38b, 39a and 39b engage in the hollows 36a and 36b, 37a and 37b. In order to achieve this, the spring element 34 must be placed onto the contact legs 10a and 10b, 12a and 12b in the direction of the arrows P as shown in FIG. 3.

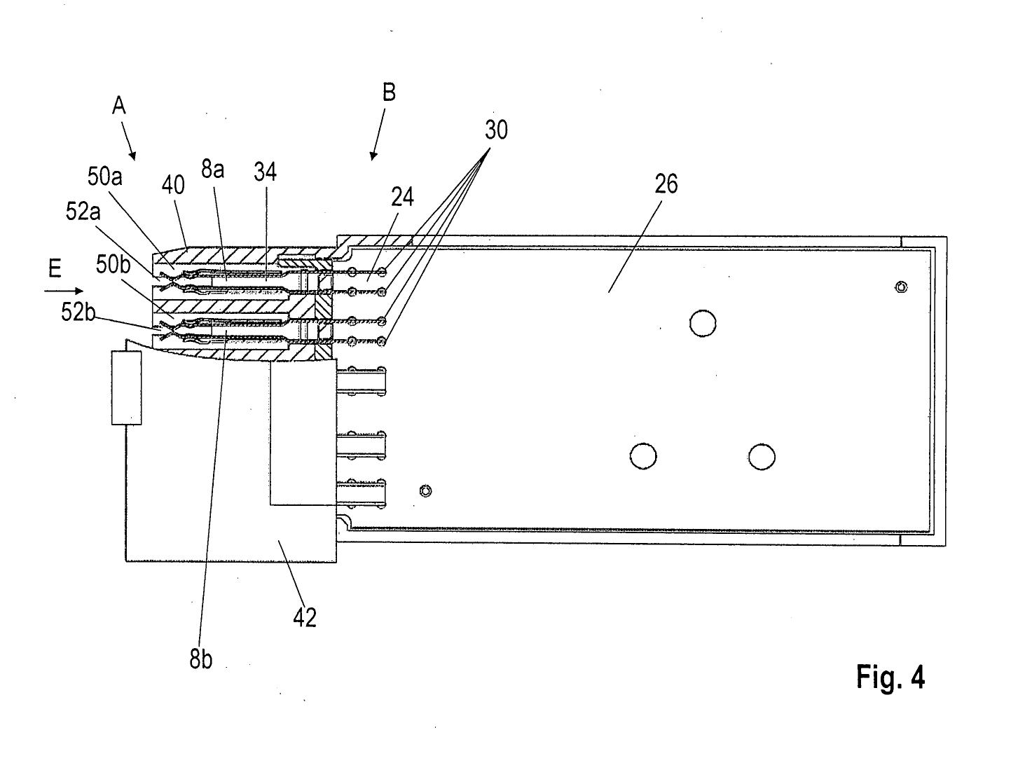

FIG. 4 is a schematic, partially sectional top view of a plug connection in which the upper housing component 42 is partially removed. The plug connection has five spring contacts 8a, 8b, 8c, 8d, 8e that are soldered parallel to one another on one side of a printed circuit board 26. The soldering pins, not shown in the depiction in FIG. 4, of the soldering lug 24 are inserted into soldering holes 30 in the printed circuit board 26.

The spring contacts 8a, 8b, 8c, 8d, and 8e are supported from underneath by a shared lower housing component 40. The spring contacts 8a, 8b, 8c, 8d, and 8e are covered from above by a shared upper housing component 42. The printed circuit board 26 is at least partially supported by the lower housing component 40. In addition, the printed circuit board can also be covered by the upper housing component 42. As shown in FIG. 4, the upper housing component 42 is of two parts, and the part of the upper housing component that covers the printed circuit board 26 is not shown.

The lower housing component 40 and the upper housing component 42 form cavities in the plug connection of which the only cavities shown in the partially cutaway depiction in FIG. 4 have reference numerals 50a and 50b. The spring contacts are situated in the cavities 50a and 50b, and the spring contacts shown in the partially cutaway view of FIG. 4 have the reference numerals 8a and 8b. The cavities 50a and 50b are open in the insertion direction E of the counterpart contact 14.

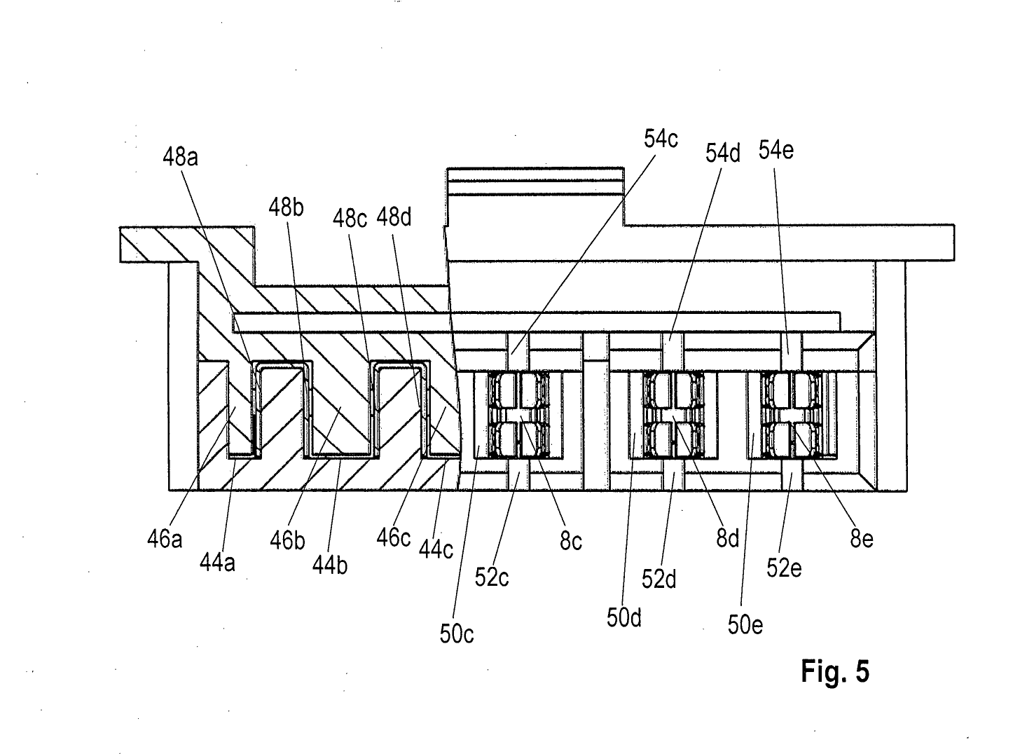

FIG. 5 is a schematic, partially sectional front view of the plug connection shown in FIG. 4.

In the cavities 50c, 50d, and 50e shown in FIG. 5, two opposing slots 52c and 54c, 52d and 54d, 52e and 54e extend perpendicular to the central longitudinal axis M, which extends into the plane of the drawing in the view of FIG. 5. The slots receive counterpart contacts 14 embodied in the form of knife blade contacts. During insertion, the respective knife blade contact is oriented so that it extends through between two opposing contact legs. The opposing slots 52c and 54c, 52d and 54d, 52e and 54e are thus situated in the plane defined by the knife blade contact.

Corresponding slots are also embodied in the cavities 50a and 50b shown in FIG. 4, and only the slots with the reference numerals 52a and 52b are shown in the partially sectional depiction in FIG. 4.

In the region of or near the spring contacts 8a and 8b shown in FIG. 4, the lower housing component 40 has a plurality of recesses of which only the ones with the reference numerals 44a, 44b, and 44c are shown in FIG. 5. The recesses 44a, 44b, and 44c extend perpendicular to the central longitudinal axis M. The recesses 44a, 44b, and 44c receive projections that are formed onto the upper housing component 42 and protrude in a comb-like fashion in the direction of the lower housing component 40, of which only the projections with the reference numerals 46a, 46b, and 46c are shown in FIG. 5. The contact legs 10a and 10b, 12a and 12b of the spring contacts 8a, 8b, 8c, 8d, and 8e with the spring legs 16a and 16b, 18a and 18b placed against them can be inserted through the vertical slots 48a, 48b, 48c, and 48d that are defined between the recesses 44a, 44b, and 44c of the lower housing component 40 and the projections 46a, 46b, and 46c of the upper housing component 42. In this instance, the slot widths are determined by the sheet thicknesses of the contact legs 10a and 10b, 12a and 12b and the spring legs 16a and 16b, 18a and 18b.

German Patent Reference 10 2007 032 992.1, the priority document corresponding to this invention, and its teachings are incorporated, by reference, into this specification.

What is claimed is:

1. A spring contact for an electrical plug connection at one end (A) having at least two spring-elastic contact legs (10a, 10b; 12a, 12b) situated opposite each other for receiving a counterpart contact (14) insertable between the two contact legs (10a, 10b; 12a, 12b) in an insertion direction (E) along a central longitudinal axis (M) of the spring contact, the spring contact comprising:
outsides of the contact legs (10a, 10b; 12a, 12b) oriented away from the central longitudinal axis (M) each engaged by respective spring legs (16a, 16b; 18a, 18b), which press the respective opposing contact legs (10a, 10b; 12a, 12b) toward each other perpendicular to the central longitudinal axis (M) and, when a counterpart contact (14) is inserted exert a respective contact pressure on the counterpart contact (14).

2. The spring contact as recited in claim 1, wherein at the one end (A), a plurality of spring-elastic contact legs (10a, 10b; 12a, 12b) are arranged opposite one another in pairs, the counterpart contact (14) is insertable between the opposing pairs of contact legs (10a, 10b; 12a, 12b) in an insertion direction (E) along the central longitudinal axis (M) of the spring contact and the outside of each contact leg (10a, 10b; 12a, 12b) is engaged by a respective spring leg (16a, 16b; 18a, 18b).

3. The spring contact as recited in claim 2, wherein the contact legs (10a, 10b; 12a, 12b) situated opposite each other are approximately V-shaped at their free ends (F) and form V-shaped contact elements (20a, 20b; 22a, 22b) that extend toward each other and contact the counterpart contact (14) when inserted.

4. The spring contact as recited in claim 3, wherein the free ends (F) of the contact legs (10a, 10b; 12a, 12b) situated opposite each other are bent and the free ends (F) are oriented away from each other.

5. The spring contact as recited in claim 4, wherein at an other end (B) the spring contact has a soldering lug (24) formed on which permits the spring contact (8a, 8b, 8c, 8d, 8e) to be soldered directly to a printed circuit board (26).

6. The spring contact as recited in claim 5, wherein the soldering lug (24) has a plurality of soldering pins (28a, 28b, 28c, 28d) formed on which extend perpendicular to the central longitudinal axis (M) of the spring contact, and can be inserted into soldering holes (30) in the printed circuit board (26).

7. The spring contact as recited in claim 6, wherein the contact legs (10a, 10b; 12a, 12b) and the soldering lug (24) with the soldering pins (28a, 28b, 28c, 28d) are integrally formed out of a metal sheet.

8. The spring contact as recited in claim 7, wherein the spring legs (16a, 16b; 18a, 18b) extend essentially parallel to the associated contact legs (10a, 10b; 12a, 12b).

9. The spring contact as recited in claim 8, wherein the spring legs (16a, 16b; 18a, 18b) are formed onto the parallel extending support walls (32a, 32b) of an essentially U-shaped spring element (34) which embraces the opposing contact legs (10a, 10b; 12a, 12b) so that insides of the support walls (32a, 32b) rest against the outsides of the contact legs (10a, 10b; 12a, 12b).

10. The spring contact as recited in claim 9, wherein the outsides of the opposing contact legs (10a, 10b; 12a, 12b) each has at least one respective hollow (36a, 36b, 37a, 37b) and the insides of the spring legs (16a, 16b; 18a, 18b) oriented toward the contact legs (10a, 10b; 12a, 12b) each has a corresponding projection (38a, 38b; 39a, 39b) formed on which engages in the respective hollow (36a, 36b, 37a, 37b).

11. The spring contact as recited in claim 10, wherein a plug connection has at least one of the spring contacts (8a, 8b, 8c, 8d, 8e).

12. The spring contact as recited in claim 11, wherein a plurality of the spring contacts (8a, 8b, 8c, 8d, 8e) are soldered parallel to one another on a side of a printed circuit board (26).

13. The spring contact as recited in claim 12, wherein the spring contacts (8a, 8b, 8c, 8d, 8e) are supported by a shared lower housing component (40) and are covered by a shared upper housing component (42).

14. The spring contact as recited in claim 13, wherein the printed circuit board (26) is at least partially supported by the lower housing component (40) and is at least partially covered by the upper housing component (42).

15. The spring contact as recited in claim 14, wherein in a region of the spring contacts (8a, 8b, 8c, 8d, 8e) and perpendicular to the central longitudinal axis (M), the lower housing component (40) has a plurality of recesses (44a, 44b, 44c) for receiving projections (46a, 46b, 46c) formed onto the upper housing component (42) and that protrude in comb-like fashion in a direction of the lower housing component (40).

16. The spring contact as recited in claim 15, wherein the contact legs (10a, 10b; 12a, 12b) with the spring legs (16a, 16b; 18a, 18b) placed against them are inserted through vertical slots (48a, 48b, 48c, 48d) defined between recesses (44a, 44b, 44c) of the lower housing component (40) and projections (46a, 46b, 46c) of the upper housing component (42) and slot widths are determined by a sheet thicknesses of the contact legs (10a, 10b; 12a, 12b) and the spring legs (16a, 16b; 18a, 18b).

17. The spring contact as recited in claim 16, wherein the lower housing component (40) and the upper housing component (42) form cavities (50a, 50b, 50c, 50d, 50e) in which the spring contacts (8a, 8b, 8c, 8d, 8e) are situated, and the cavities (50a, 50b, 50c, 50d, 50e) are open at least in the insertion direction (E) of the counterpart contact (14).

18. The spring contact as recited in claim 17, wherein each of the cavities (50a, 50b, 50c, 50d, 50e) contains at least two opposing slots (52a; 52b; 52c, 54c; 52d, 54d; 52e, 54e) extending perpendicular to the central longitudinal axis (M) and that are used for insertion of counterpart contacts (14) in a form of knife blade contacts.

19. The spring contact as recited in claim 1, wherein the contact legs (10a, 10b; 12a, 12b) situated opposite each other are approximately V-shaped at their free ends (F) and form V-shaped contact elements (20a, 20b; 22a, 22b) that extend toward each other and contact the counterpart contact (14) when inserted.

20. The spring contact as recited in claim 1, wherein free ends (F) of the contact legs (10a, 10b; 12a, 12b) situated opposite each other are bent and the free ends (F) are oriented away from each other.

21. The spring contact as recited in claim 1, wherein at an other end (B) the spring contact has a soldering lug (24) formed on which permits the spring contact (8a, 8b, 8c, 8d, 8e) to be soldered directly to a printed circuit board (26).

22. The spring contact as recited in claim 1, wherein the spring legs (16a, 16b; 18a, 18b) extend essentially parallel to the associated contact legs (10a, 10b; 12a, 12b).

23. The spring contact as recited in claim 1, wherein the spring legs (1 6a, 16b; 18a, 18b) are formed onto the parallel extending support walls (32a, 32b) of an essentially U-shaped spring element (34) which embraces the opposing contact legs (10a, 10b; 12a, 12b) so that insides of the support walls (32a, 32b) rest against the outsides of the contact legs (10a, 10b; 12a, 12b).

24. The spring contact as recited in claim 1, wherein the outsides of the opposing contact legs (10a, 10b; 12a, 12b) each has at least one respective hollow (36a, 36b, 37a, 37b) and insides of the spring legs (16a, 16b; 18a, 18b) oriented toward the contact legs (10a, 10b; 12a, 12b) each has a corresponding projection (38a, 38b; 39a, 39b) formed on which engages in the respective hollow (36a, 36b, 37a, 37b).

25. The spring contact as recited in claim 1, wherein a plug connection has at least one of the spring contacts (8a, 8b, 8c, 8d, 8e).

26. The spring contact as recited in claim 11, wherein the spring contacts (8a, 8b, 8c, 8d, 8e) are supported by a shared lower housing component (40) and are covered by a shared upper housing component (42).

27. The spring contact as recited in claim 11, wherein in a region of the spring contacts (8a, 8b, 8c, 8d, 8e) and perpendicular to the central longitudinal axis (M), the lower housing component (40) has a plurality of recesses (44a, 44b, 44c) for receiving projections (46a, 46b, 46c) formed onto the upper housing component (42) and that protrude in comb-like fashion in a direction of the lower housing component (40).

28. The spring contact as recited in claim 13, wherein the lower housing component (40) and the upper housing component (42) form cavities (50a, 50b, 50c, 50d, 50e) in which the spring contacts (8a, 8b, 8c, 8d, 8e) are situated, and the cavities (50a, 50b, 50c, 50d, 50e) are open at least in the insertion direction (E) of the counterpart contact (14).
